(19) United States
(12) Patent Application Publication
(10) Pub. No.: US 2014/0007010 A1
(43) Pub. Date: Jan. 2, 2014

(54) METHOD AND APPARATUS FOR DETERMINING SENSORY DATA ASSOCIATED WITH A USER

(71) Applicant: Jan Otto Blom, Lutry (CH)

(72) Inventor: Jan Otto Blom, Lutry (CH)

(73) Assignee: Nokia Corporation, Espoo (FI)

(21) Appl. No.: 13/538,289

(22) Filed: Jun. 29, 2012

(51) Int. Cl. G06F 3/048

(52) U.S. Cl. 715/825

(57) ABSTRACT

An approach is provided for processing sensory data, presenting situational awareness information, and providing adaptive services and content to the user. A data collection module processes and/or facilitates a processing of sensor data associated with at least one user to determine one or more activities. Then, the data collection module processes and/or facilitates a processing of the sensor data to cause, at least in part, a classification of the one or more activities into one or more primary activities, one or more secondary activities, or a combination thereof. The data collection module further comprises causes a presentation of at least one user interface for interacting with at least one of the one or more activities, one or more content items, one or more applications, or a combination thereof based, at least in part, on the classification.

### BACKGROUND

Service providers (e.g., wireless, cellular, etc.) and device manufacturers are continually challenged to deliver value and convenience to consumers by, for example, providing compelling network services. One area of development has been proliferation of various sensors available on user devices (e.g., mobile phones, tablets, etc.), in physical spaces (e.g., offices, buildings, homes, etc.), in automobiles (e.g., directional, accelerometer, etc.), personal sensors (e.g., health and wellness), and the like, wherein the sensors may be associated with one or more networks (e.g., sensor networks, service provider networks, etc.) For example, these sensors may be able to detect audio, video, biometrical, physiological, environmental, and the like data, wherein the data may be processed to determine contextual information associated with the users, the user devices, the environment, and the like. Further, as the users utilize the user devices to perform tasks and multitasks in various situations, the sensors may be utilized to detect user activity, environmental, and contextual information for providing optimized and appropriate user device functionalities, applications, content, processes, network services, and the like to the users according to the data collected by the various sensors. Accordingly, service providers and device manufacturers face significant challenges to enabling utilization of the sensors, collecting and processing of the associated data, and providing appropriate and compelling services to the users.

### SOME EXAMPLE EMBODIMENTS

Therefore, there is a need for an approach for processing sensory data, presenting situational awareness information, and providing adaptive services and content to the user.

According to one embodiment, a method comprises processing and/or facilitating a processing of sensor data associated with at least one user to determine one or more activities. The method also comprises processing and/or facilitating a processing of the sensor data to cause, at least in part, a classification of the one or more activities into one or more primary activities, one or more secondary activities, one or more peripheral activities, or a combination thereof. The method further comprises causing, at least in part, a presentation of at least one user interface for interacting with at least one of the one or more activities, one or more content items, one or more applications, or a combination thereof based, at least in part, on the classification.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of sensor data associated with at least one user to determine one or more activities. The apparatus is also caused to process and/or facilitate a processing of the sensor data to cause, at least in part, a classification of the one or more activities into one or more primary activities, one or more secondary activities, one or more peripheral activities, or a combination thereof. The apparatus is further caused to cause, at least in part, a presentation of at least one user interface for interacting with at least one of the one or more activities, one or more content items, one or more applications, or a combination thereof based, at least in part, on the classification.

According to another embodiment, a computer-readable storage medium carrying one or more sequences of one or more instructions which, when executed by one or more processors, cause, at least in part, an apparatus to process and/or facilitate a processing of sensor data associated with at least one user to determine one or more activities. The apparatus is also caused to process and/or facilitate a processing of the sensor data to cause, at least in part, a classification of the one or more activities into one or more primary activities, one or more secondary activities, one or more peripheral activities, or a combination thereof. The apparatus is further caused to cause, at least in part, a presentation of at least one user interface for interacting with at least one of the one or more activities, one or more content items, one or more applications, or a combination thereof based, at least in part, on the classification.

According to another embodiment, an apparatus comprises means for processing and/or facilitating a processing of sensor data associated with at least one user to determine one or more activities. The apparatus also comprises means for processing and/or facilitating a processing of the sensor data to cause, at least in part, a classification of the one or more activities into one or more primary activities, one or more secondary activities, one or more peripheral activities, or a combination thereof. The apparatus further comprises means for causing, at least in part, a presentation of at least one user interface for interacting with at least one of the one or more activities, one or more content items, one or more applications, or a combination thereof based, at least in part, on the classification.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of processing sensory data, presenting situational awareness information, and providing adaptive services, applications, and/or content to the user, according to an embodiment;

FIG. 2 is a diagram of the components of a user equipment capable of data collection and analysis for determining a user activity, according to an embodiment;

FIGS. 3-5 are flowcharts of processes processing sensory data, presenting situational awareness information, according to various embodiments;

FIG. 6 is a table including example sensors and possible various stimuli types, according to various embodiments;

FIG. 7 illustrates examples of UI diagrams for interacting with the UE 101, according to various embodiments;

FIG. 8 illustrates various devices for detecting sensory data in various user situations, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for processing sensory data, presenting situational awareness information, and providing adaptive services and content to the user. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

It is noted that embodiments of the approach described herein are applicable to any type of sensor including environmental sensors, sensors for physical properties, material sensors, location sensors, health and wellness sensors, personal sensors, wireless sensors, wired sensors, virtual sensors, network sensors, and the like.

In general, situational awareness is ability for individuals to identify, process, and comprehend information about what is happening at a particular time and space. For instance, an individual/user may be typing an email, keeping an eye on any incoming communications on his phone, as well as paying attention to people who are visible in the user's surroundings. In other words, it is for an individual to know what is going on in his surroundings. For example, when an individual is driving a vehicle on a road, he needs to be aware of other cars around him, various traffic signs and signals, possible pedestrians in the area, and information presented via various indicators in the vehicle (e.g., speed, vehicle status, etc.) However, situational awareness is dynamic, hard to maintain, and easy to lose if individuals are busy with multiple tasks and events occurring simultaneously, especially during complex, high stress, and demanding tasks. Nevertheless, the situational awareness may be retained and/or improved upon if individuals have timely and relevant information about their surroundings and can process the information for assessing and re-assessing their situation, for example, by anticipating, predicting, and/or adapting to task demands efficiently.

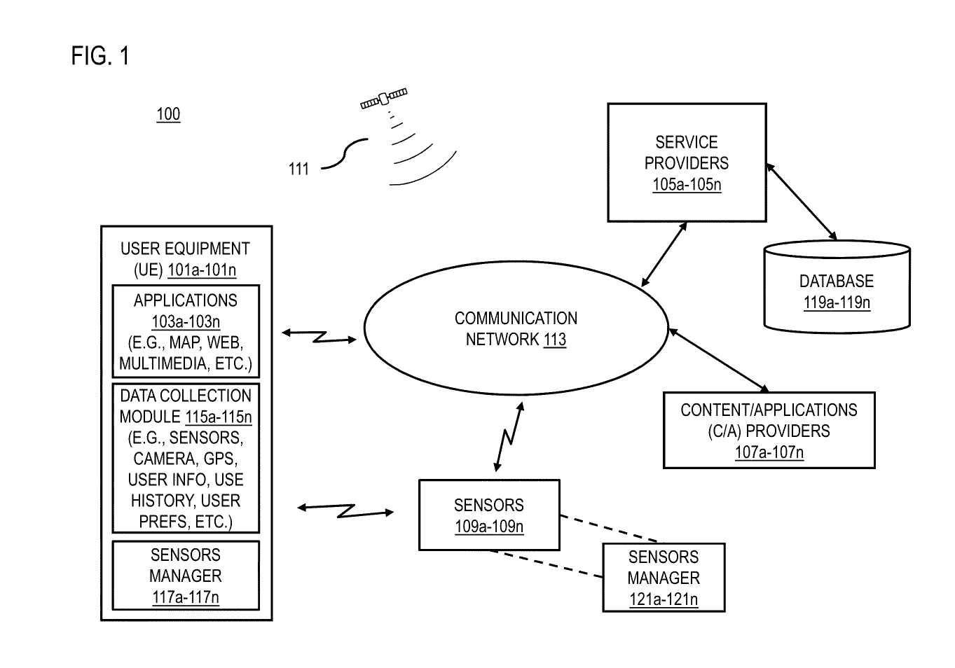

FIG. 1 is a diagram of a system capable of processing sensory data, presenting situational awareness information, and providing adaptive services, applications, and/or content to the user, according to an embodiment. As discussed above, an individual can simultaneously maintain a situational awareness of his surroundings across multiple modalities (e.g., multiple sensory inputs). For example, an individual in a room may be viewing a computer monitor, typing at a computer keyboard, hearing a conversation taking place nearby, while having various people/objects in the room in his peripheral view. In similar situations, the individual utilizes various modalities to register and process different stimuli and as necessary, adapt his focus to one primary task (e.g., read text on the computer monitor), while maintaining other inputs as secondary tasks. However, as individuals/users utilize various user devices to perform various tasks and multitasks, in many instances, it would be challenging for a user to simultaneously process information from all sensory modalities and focus on each task, which may also present a high cognitive load. In general, cognitive load can be considered to be an amount of memory and processing power (e.g., brain power) required for an individual to process, understand, and/or perform various tasks (e.g., perception, problem solving, retrieving information from memory, etc.), wherein the various tasks and timing of the tasks may present various cognitive loads for the individual. In one scenario, cognitive load of a user may be inferred based on a number of tasks the user may be registered to be involved in (e.g., a primary task, several secondary tasks, and various peripheral activities). For instance, it may be nearly impossible for a user to focus his visual attention on a driving task while attempting to read a text message on a mobile device without either one of the tasks suffering.

In many instances, various user devices may present various information and notifications to the user, which the user may not be able to attend to right away. Furthermore, with proliferation of sensor utilization in the various user devices and by service providers (e.g., location-based services), the user devices (e.g., included sensors) are also becoming increasingly interconnected (e.g., via cloud-based services), wherein it may be possible to detect a user's interaction not only with one user device, but across a plurality of user devices. Moreover, wireless sensor networks are also becoming increasingly common; for example, deployed in smart buildings, on a user's body (e.g., for biometric, physiological data), in public infrastructure (e.g., for environmental monitoring), and the like. However, as the users utilize the various user devices and sensor information in performing various tasks (e.g., conducting a meeting) and receiving information (e.g., SMS messages, IM messages, etc.), they may be challenged with an overload of information and requests for attention from the various user devices and sensors.

To address, at least these problems, a system 100 of FIG. 1 presents the capability for processing sensory data, presenting situational awareness information, and providing adaptive services, applications, and/or content to the user. More specifically, a system 100 of FIG. 1 introduces the capability of utilizing various sensors available on user devices, in nearby proximity, and/or via a network of sensors to provide various services, applications, processes, notifications, and the like to the user so that the user may be able to maintain surrounding situational awareness. Further, the system 100 may “extend” sensory capabilities of a user by presenting (e.g., via a user interface on a user device) additional sensory information, which the user may not be able to sense at a given time and a given space, for example, a presentation in a nearby room or an SMS message received at a time when the user was not able to view display of his user device. Furthermore, with the proliferation of use of various sensors, a user's environment (e.g., an office space) may include various sensors, for example, on user devices (e.g., mobile phones, tablets, etc.), standalone sensors (e.g., a room camera, microphone, motion detector, etc.), user physiological sensors (e.g., health, wellness, etc.), which may detect and collect various data associated with the user, the user devices, the user environment, and the like. For instance, the sensors may be able to capture audio, video, images, location information, ambient temperature, user mood, user activity, other activities (e.g., nearby, at a remote location, etc.), and the like, wherein one or more applications and/or algorithms may utilize the sensors' data to perform a face recognition, a voice recognition, a gesture recognition, and/or other processes. Additionally, the sensor data of the proximity of the user may be utilized to create a high overlap with subjective sensing process of the user. For instance, a microphone situated in the same room as the user will match the subjective auditory perception. In another example, sensory data from a camera mounted on the user's head (e.g., in glasses, in a headphone device, etc.) may naturally follow the direction of the head when the user moves his head around. In one scenario, sensor data may be utilized to determine/infer whether a stimuli feature is in the center or periphery of the user's attention/focus. For instance, eye tracking technology may be utilized to determine area of visual field the user is currently focusing on, allowing distinction to be made between visual stimuli in the center and periphery of the visual attention.

In various embodiments, in addition to physical sensors tracking the environment of the user, virtual sensors running on a range of user devices (e.g., mobile phones, game consoles, PC's, etc.) that the user may be using can be utilized to track applications, services, and/or processes or running on the user devices. The data captured by each of the sensors may be analyzed in order to identify stimuli or processes in the physical and/or virtual (e.g., digital) environments of the user competing for user's attention along each of the sensory modalities.

In various embodiments, the various sensors may be utilized to capture various sensor data, which may be processed to determine (e.g., approximate) and present to the user situational awareness information associated with the user, one or more user devices, and/or user environment. In one scenario, various sensors including user sensors (e.g., personal body area), sensors on various user devices, as well as sensors embedded in the environment of the user collect various data (e.g., audio, video, movements, physiological, etc.), which may be aggregated, processed, and/or classified by a user device, a network server, a service provider, and the like. In one embodiment, the sensory data may indicate and/or approximate the sensory experience associated with the user, wherein specific stimuli are identified relevant to one or more sensorial modalities. For example, visual perception, people, text, and physical objects may be determined/identified to be within visual field of the user.

In one embodiment, one or more primary and/or one or more secondary activities of the user are inferred and dynamically updated, wherein an intensity of the primary task as well as the number of the activities identified as candidates for primary activities are used to determine stress level of the user within a given modality. Further, knowledge of the primary and/or secondary activities may be utilized to provide feedback and/or assistance to the user for one or more interactions with various user devices, applications, services, and/or processes. In various embodiments, one or more user interface (UI) elements on the one or more user devices may be utilized to present various information associated with the one or more processes, applications, services, primary and/or secondary tasks of the user, and/or one or more peripheral events.

In one embodiment, one or more sensor data (e.g., input stream) and/or certain portions of the one or more sensor data may be submitted/uploaded to a service provide (e.g., cloud-based) for further processing, for example, utilize machine vision techniques can be incorporated on the cloud to obtain maximal processing power. In one embodiment, processing tasks of the one or more sensor data may be distributed to one or more user and/or network devices available in proximity of a user device.

As shown in FIG. 1, in one embodiment, the system 100 includes user equipment (UE) 101a-101n (also collectively referred to as UE 101 and/or UEs 101), which may be utilized to execute one or more applications 103a-103n (also collectively referred to as applications 103) including games, social networking, web browser, media application, user interface (UI), map application, web client, etc. to communicate with other UEs 101, one or more service providers 105a-105n (also collectively referred to as service provider 105), one or more content/applications providers 107a-107n (also collectively referred to as C/A providers 107), one or more sensors 109a-109n (also collectively referred to as sensors 109), GPS satellite 111, and/or with other components of a communication network 113 directly and/or over the communication network 113. In one embodiment, the UEs 101 may include data collection modules 115a-115n (also collectively referred to as data collection module 115) for determining and/or collecting data associated with the UEs 101, one or more sensors of the UE 101, one or more users of the UEs 101, applications 103, one or more content items, and the like.

In one embodiment, the UEs 101 may include sensors manager 117a-117n (also collectively referred to as sensors manager 117) for managing various sensors. In one embodiment, the service provider 105 may include and/or have access to one or more database 119a-119n (also collectively referred to as database 119), which may include various user information, user profiles, user preferences, one or more profiles of one or more user devices (e.g., device configuration, sensors information, etc.), service provider information, other service provider information, and the like. In addition, the UE 101 can execute an application 103 that is a software client for storing, processing, and/or forwarding the sensor data to other components of the system 100. In one embodiment, the sensors 109 may include one or more sensors managers 121a-121n ((also collectively referred to as sensors manager 121) for managing the sensors 109, processing data collected by the sensors 109, and/or interfacing with the UEs 101, the service providers 105, other components of the system 100, or a combination thereof. In various embodiments, the sensors 109 may include one or more stationary sensors in a spatial proximity of the user (e.g., a camera installed in an office space) and/or may be mobile (e.g., may follow the user).

In various embodiments, the UEs 101 may include various sensors and/or may interact with the sensors 109, wherein the UEs 101 and/or the sensors 109 may include a combination of various sensors, for example, one or more wearable sensors, accelerometers, physiological sensors, biometric sensors. By way of example, connectivity between the UEs 101 and the sensors 109 and/or sensors manager 121 may be facilitated by short range wireless communications (e.g., Bluetooth®, WLAN, ANT/ANT+, ZigBee, etc.)

In one embodiment, a user may wear one or more sensors (e.g., a microphone, a camera, an accelerometer, etc.) for monitoring and collection of sensor data (e.g., images, audio, etc.) For example, the sensors may capture accelerometer, image, and audio information at periodic intervals. The UEs 101 (e.g., via the application 103 and/or the sensors manager 117) may store the data temporarily, perform any needed processing and/or aggregation, and send the data to the service providers 105 continuously and/or at periodic intervals. In one embodiment, the data sent includes, at least in part, timestamps, sensor data (e.g., physiological data), and/or context information (e.g., activity level). By way of example, the operational states of the sensors on the UEs 101 and/or the sensors 109 may include setting and/or modifying related operational parameters including sampling rate, parameters to sample, transmission protocol, activity timing, etc. By way of example, the sensors manager 117 and/or 121 includes one or more components for providing adaptive filtering of sensors and/or sensor data. In one embodiment, the sensors managers 117 and/or 121 may execute at least one algorithm for executing functions of the sensors managers.

In one embodiment, the system 100 processes and/or facilitates a processing of sensor data associated with at least one user to determine one or more activities. In various embodiments, a user may utilize one or more user devices (e.g., a personal computer, a mobile phone, a tablet, etc.), which may include various sensors (e.g., audio, video, image, GPS, accelerometer, etc.) for capturing and determining information about the user, the UEs 101, and/or environment of the user and/or the UEs 101. For example, the sensors may capture an image and/or audio sample of the user and utilize one or more activity recognition algorithms to determine if the user is sitting, speaking, walking, looking at a computer monitor, typing at the computer keyboard, looking at a certain direction, user gestures, facial expressions of the user, and the like. In one embodiment, the UE 101 may interact with other sensors in a spatial proximity, for example, available in a room (e.g., an office), in a building, outside (e.g., around a neighborhood), and the like.

In one embodiment, the system 100 processes and/or facilitates a processing of the sensor data to cause, at least in part, a classification of the one or more activities into one or more primary activities, one or more secondary activities, one or more peripheral activities, or a combination thereof. In various embodiments, the applications 103, the sensors managers 117 and/or 121 may process sensor data captured by one or more sensors of the UE 101 and/or the sensors 109 in order to determine one or more classifications for the one or more activities, for example, as a primary activity, as one or more secondary activities, as one or more peripheral activities, and the like. In one instance, the sensor data may indicate that a user's primary activity is talking on a phone, but at the same time the user is utilizing as application to check for emails. In another example, the user's primary activity may be typing at a computer keyboard while listening and waiting for a conference call to begin. In one example, the user primary activity may be conducting a conference call on one UE 101, while viewing an instant message (IM) notification on another UE 101.

In one embodiment, the system 100 causes, at least in part, a presentation of at least one user interface for interacting with at least one of the one or more activities, one or more content items, one or more applications, or a combination thereof based, at least in part, on the classification. In one embodiment, the applications 103 may present a UI including one or more diagrams, notifications, and/or elements for the user to review and interact with. For example, the user may select an element related to a primary activity, a phone call, to view additional information about the activity such as parties included in the activity, duration of the activity, applications in use, content items being consumed, and the like. In one example, the user may select from one or more secondary activities for further interaction such as reorder the classifications, rearrange the presentation, and the like. In one embodiment, the user may select to switch the classifications of the primary activity and that of the one or more secondary activities.

In one embodiment, the system 100 causes, at least in part, a categorization of the one or more content items, the one or more applications, or a combination based, at least in part, on an association with the one or more primary activities, the one or more secondary activities, the one or more peripheral activities, or a combination thereof, wherein the at least one user interface depicts the one or more activities, the one or more content items, the one or more services, or a combination thereof based, at least in part, on the categorization. In one embodiment, a UI presentation may indicate one or more activities which utilize one or more content items and/or applications, wherein the content items and/or the applications may be categorized based on their association with the primary, secondary, and/or peripheral activities. For example, a UI diagram may present information that a user may be associated with a primary activity of an IM session, wherein a texting application is in use and wherein the texting application is categorized as being utilized by the user for a primary activity.

In one embodiment, the system 100 processes and/or facilitates a processing of the sensor data to determine cognitive load information associated with the at least one user. In various embodiments, a user may be involved with one or more activities on one or more UEs 101, for example, a phone call, typing at a keyboard, reading a text message, taking part in a conversation, and the like, wherein one or more user sensory capabilities are being utilized. Further, the applications 103, the data collection module 115, and/or the sensors manager 117 may determine/infer/approximate the cognitive load of the user, for example, intellectual processing capability required for the user to execute and process information associated with the one or more activities, wherein the cognitive load information may be utilized (e.g., by a UE 101, a service provider, etc.) to determine how and/or when any interruptions by an application, by a service, by a content, and the like should be handled. In one embodiment, if a user is estimated to be experiencing a high cognitive load (e.g., due to a large number of concurrent tasks and/or loading nature of any given task), one or more presentations, recommendations, prompts, interruptions, and the like may be delayed and/or delivered with minimal impact on the user and/or current tasks in progress. For example, when a user is engaged in a visually demanding task (e.g., driving a vehicle, typing an email, etc.), a notification of an incoming phone call, an SMS, and the like should not require visual attention from the user so not to present additional load to visual modality of the user. In another embodiment, during a high cognitive load, notifications/interruptions may be stopped and/or filtered such that only high priority events and notifications are presented to the user.

In one embodiment, the system 100 causes, at least in part, a presentation of the least one user interface depicting information associated with the cognitive load information, the one or more primary activities, the one or more secondary activities, the one or more peripheral activities, or a combination thereof in a primary, a secondary, or a peripheral section of the least one user interface. In various embodiments, the applications 103, the data collection module 115, and/or the service providers 105 may process one or more sensors data (e.g., audio, image, facial recognition, eye movement tracking, etc.) and determine that a user is more active with a secondary activity than with a primary activity, wherein a recommendation may be presented to the user (e.g., via UI) for switching the user focus from one or more activities to one or more other activities currently presented, for example, switch focus from a primary to a secondary and/or a peripheral activity.

In one embodiment, the system 100 causes, at least in part, a categorization of the sensor data, the one or more activities, or a combination thereof into one or more sensory modalities, wherein the presentation is with respect to the one or more sensory modalities. In various embodiments, the applications 103, the sensors manager 117 and/or 121, the service providers 105, and/or the data collection module 115 may process and categorize the one or more sensors data and/or the one or more user activities into one or more user sensory modalities. Further, the presentation and/or the recommendation to switch the primary and secondary activities may be based on the categorization associated with the one or more sensory modalities. For example, a primary activity is associated with an auditory modality (e.g., speaking on the phone) and a secondary activity is associated with typing at a keyboard; however, after some time, one or more sensors 109 and/or the sensors managers 117 and/or 121 determine that there is no auditory signals (e.g., user is not speaking, but still on the phone), wherein a recommendation is presented to the user for switching primary, secondary, and/or peripheral activities.

In one embodiment, the system 100 processes and/or facilitates a processing of the sensor data to determine an occurrence of one or more stimuli. In various embodiments, the data collection module 115 and/or the sensors managers 117 and/or 121 may receive and/or process one or more sensor data available from one or more sensors on the UEs 101 and/or from the sensors 109, wherein the data may indicate occurrence of one or more stimuli from one or more sources. For example, a sensor may capture ringing of a phone, ringing of a door bell, a person walking into a room, a person speaking with a user, a notification of a reminder alarm on the UEs 101, and the like. In one embodiment, the one or more stimuli may be in close proximity with the user and/or may be at a distance from the user, but may still be detected by one or more sensors on the UEs 101 and/or the sensors 109. For example, a camera and a microphone may detect and/or record a presentation, which the user may wish to be notified of. In another example, a microphone may detect the name of a particular user being announced in a meeting room where the user is to be present at.

In one embodiment, the system 100 processes and/or facilitates a processing of the sensor data to determine response information of the at least one user to the one or more stimuli, wherein the cognitive load information, the presentation, the classification of the one or more activities, or a combination thereof is based, at least in part, on the response information. In various embodiments, the one or more sensors on the UEs 101 and/or 109 may capture one or more responses by one or more users to the one or more stimuli, wherein the data collection module 115 may process and the one or more responses for determining one or more activities. Further, the applications 103, the data collection module 115, and/or the service provider 105 may determine one or more cognitive load information, presentations, classifications, and/or categorizations based on the one or more responses. For example, a user responds to a ringing telephone by answering it; a user responds to an IM on a UE 101; a user responds to another user by waving his hand, and the like.

In one embodiment, the system 100 causes, at least in a part, a filtering of the one or more stimuli based, at least in part, on user profile information, user preference information, historical information, or a combination thereof. In one embodiment, the data collection module 115 and/or the applications 103 determine one or more stimuli intended for a user, wherein the one or more stimuli may be filtered (e.g., sorted) based on one or more parameters associated with the user and the UE 101. For example, one or more sensors may detect a stress level of the user (e.g., skin moisture, galvanic skin response, heart rate variation, etc.) currently involved in one or more activities (e.g., speaking loudly into a UE 101, reviewing a slide show on another UE 101), when a notification of a new stimulus (e.g., an SMS message) is received by one or more UEs 101. In one embodiment, the filtering of the one or more stimuli may be based on a user profile, device profile, user history, location information, current activity level, current cognitive load, current user status, and the like.

In one embodiment, the system 100 causes, at least in part, a presentation of the one or more stimuli, at least one notification of the one or more stimuli, or a combination thereof based, at least in part, on the filtering. In one embodiment, the system 100 can determine a scheduling for presenting the notification of the new stimulus so that there are no interruptions to the user at the current time (e.g., present the notification after the user is done with the call and the stress level is lower). In various embodiments, the applications 103 and/or the data collection module 115 may determine contextual information associated with one or more current activities of a user, wherein presentation of one or more notification of one or more subsequent stimuli may be determined based on the contextual information. For example, the user may be speaking on the phone with a client regarding a project for the client and concurrently typing a message at UE 101 keyboard intended for the client, when the user receives an urgent SMS from his colleague related to the project and/or the client, wherein the notification of the new urgent SMS is presented to the user without delay.

In one embodiment, the system 100 determines intensity level information of the one or more primary activities, the one or more secondary activities, the one or more peripheral activities, or a combination thereof. In various embodiments, the one or more sensors on the UEs 101, the sensors 109, and/or the respective sensors managers 117 and/or 121 may process data captured by the one or more sensors for determining an intensity level associated with one or more activities of the user (e.g., physiological information of the user). For example, physical characteristics of a user and/or the UE 101 may be determined based on sensor data captured and processed indicative of one or more user physiological reactions, facial recognition, gesture detection, tone and/or level of voice, eye movements, UEs 101 movements, and the like.

In one embodiment, the system 100 determines a number of the one or more primary activities, the one or more secondary activities, the one or more peripheral activities, or a combination thereof, wherein the cognitive load information is based, at least in part, on the intensity level information, the number, or a combination thereof. In various embodiments, the cognitive load information is calculated/determined based on the number of the user's primary and/or secondary activities and the respective intensity levels associated with the activities. For example, if a user is driving a car on a highway (e.g., at high speed, primary task) while speaking with a passenger in the car (e.g., secondary task), then the system 100 may determine that the user currently has a higher cognitive load (e.g., driving fast and conversing). In another example, a user may be walking around at a technical conference, reviewing a product brochure (e.g., primary activity) at a booth, listening to a representative describing information in the brochure (e.g., secondary activity), and listening to the overhead announcements for information on a particular presentation to begin in a few minutes (e.g., secondary activity), wherein the system 100 may determine a lower cognitive load for the user.

In one embodiment, the system 100 determines the one or more activities, the one or more primary activities, the one or more secondary activities, the one or more peripheral activities, or a combination thereof based, at least in part, on a proximity to the at least one user, at least one device associated with the at least one user, or a combination thereof, wherein the proximity is based, at least in part, on a spatial proximity, a virtual proximity provided by one or more remote sensors, or a combination thereof. In one embodiment, the UE 101 may determine proximity (e.g., in a same room, at the next door office, at the meeting room on a different floor, in the backyard, etc.) of an activity in relation to the user and/or the UE 101, wherein the detection of the activity may be via the UE 101, one or more other UEs 101, one or more remote sensors, via the service provider 105, and the like. In one example, a UE 101 may detect a user of the UE 101 walking towards a meeting room while conversing on a phone via the UE 101 and/or a different UE 101, wherein the UE 101 may present a notification (e.g., the user is walking towards the meeting room) to another user via another UE 101 and/or sensors 109.

In one embodiment, the system 100 determines one or more events associated with the one or more activities. In one embodiment, the applications 103 may determine contextual information associated with one or more user activities (e.g., speaking on a phone with a colleague) and one or more events which may be associated with the one or more activities. For example, the user may be discussing an office team meeting with a colleague, wherein the applications 103 and/or the data collection module 115 may determine that notifications (e.g., emails) may need to be sent out to members of the team. In one example, the UE 101 detects that a user is stopping his car at a fueling station (e.g., via a location sensor), determines that the fuel level is low (e.g., via a sensor in the car), infers that the user most likely will refuel the car, wherein the UE 101 calculates, presents, shares, and/or records a fuel consumption rate since last refueling of the car.

In one embodiment, the system 100 causes, at least in part, a creation of one or more records of the classification, the one or more content items, the one or more applications, or a combination thereof. In various embodiments, the applications 103 and/or the data collection module 115 may create one or more records for the one or more classifications, content items, and/or applications associated with the one or more activities, the user, and/or the UEs 101. For example, a record may indicate an application utilized in one or more activities at a particular location, at a particular time, on a particular UE 101, and the like. In one example, an audio sample and an image capture may be associated with a record of one or more activities.

In one embodiment, the system 100 causes, at least in part, an association of the one or more records with the one or more events. In various embodiments, the applications 103 and/or the service provider 105 may associate the one or more records with the one or more events, the one or more activities, and the like. For example, a transcript of a conference call is associated with the conference call having taken place earlier. In one example, a record of a meeting with a colleague may associate one or more parameters of the meeting (e.g., attendees, time, place, topics discussed, etc.) with the event of the meeting.

In one embodiment, the system 100 determines one or more situational contexts based, at least in part, on the one or more activities, the one or more primary activities, the one or more secondary activities, the one or more peripheral activities, or a combination thereof. In one example, the user may be working in his backyard (e.g., a primary activity) while listening to music playing on a nearby music player (e.g., secondary activity), when a UE 101 near the user may detect (e.g., via a thermometer) that ambient temperature is rising and the user heart rate is increasing (e.g., via a sensor on the user body), wherein the UE 101 may produce a notification regarding the heat and his physiological condition. In one example, a user is at a party and engaged in a conversation with another person, wherein the UE 101 may detect (e.g., via audio sampling) name of the user being uttered by other persons nearby and presents a notification to the user via a UI.

In one embodiment, the system 100 determines the at least one user interface, the one or more content items, the one or more applications, or a combination thereof based, at least in part, on the one or more situational contexts. In one embodiment, the application 103 and/or the service provider 105 may determine an appropriate UI notification based on the situation of the user. For example, the user in the party of above example may be presented with a UI notification such that it is not intrusive (e.g., a short beep along with a short message on the UE 101 display) or noticeable by the other persons near the user. In one example, a user engaged in a conversation in a loud surrounding (e.g., at a bar in an airport) may receive a more robust notification (e.g., sounds, vibration, flashing screen, etc.) about a change in an imminent travel itinerary.

Although various embodiments are discussed with respect to processing example sensory data associated with a user, it is contemplated that embodiments of the approach described herein are applicable to any type of sensory data including environmental, physical properties, material, location sensors, user device, and the like. In one embodiment, the sensory data refers, for instance, to data that indicates state of the device, state of the device environment and/or the inferred state of a user of the device. The states indicated by the sensory data, for instance, described according to one or more “contextual parameters” including time, recent applications running on the device, recent World Wide Web pages presented on the device, keywords in current communications (such as emails, SMS messages, IM messages), current and recent locations of the device (e.g., from a global positioning system, GPS, or cell tower identifier), environment temperature, ambient light, movement, transportation activity (e.g., driving a car, riding the metro, riding a bus, walking, cycling, etc.), activity (e.g., eating at a restaurant, drinking at a bar, watching a movie at a cinema, watching a video at home or at a friend's house, exercising at a gymnasium, traveling on a business trip, traveling on vacation, etc.), emotional state (e.g., happy, busy, calm, rushed, etc.), interests (e.g., music type, sport played, sports watched), contacts, or contact groupings (e.g., family, friends, colleagues, etc.), among others, or some combination thereof.

By way of example, the communication network 113 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 may be any type of mobile terminal, fixed terminal, or portable terminal including a mobile handset, station, unit, device, healthcare diagnostic and testing devices, product testing devices, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs can support any type of interface to the user (such as “wearable” circuitry, etc.). Further, the UEs 101 may include various sensors for collecting data associated with a user, a user's environment, and/or with a UE 101, for example, the sensors may determine and/or capture audio, video, images, atmospheric conditions, device location, user mood, ambient lighting, user physiological information, device movement speed and direction, and the like.

By way of example, the UEs 101, the service provider 105, the C/A providers 107, and the sensors 109 may communicate with each other and other components of the communication network 113 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, one or more entities of the system 100 may interact according to a client-server model with the applications 103 and/or the sensors manager 117 of the UE 101. According to the client-server model, a client process sends a message including a request to a server process, and the server process responds by providing a service (e.g., context-based grouping, social networking, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

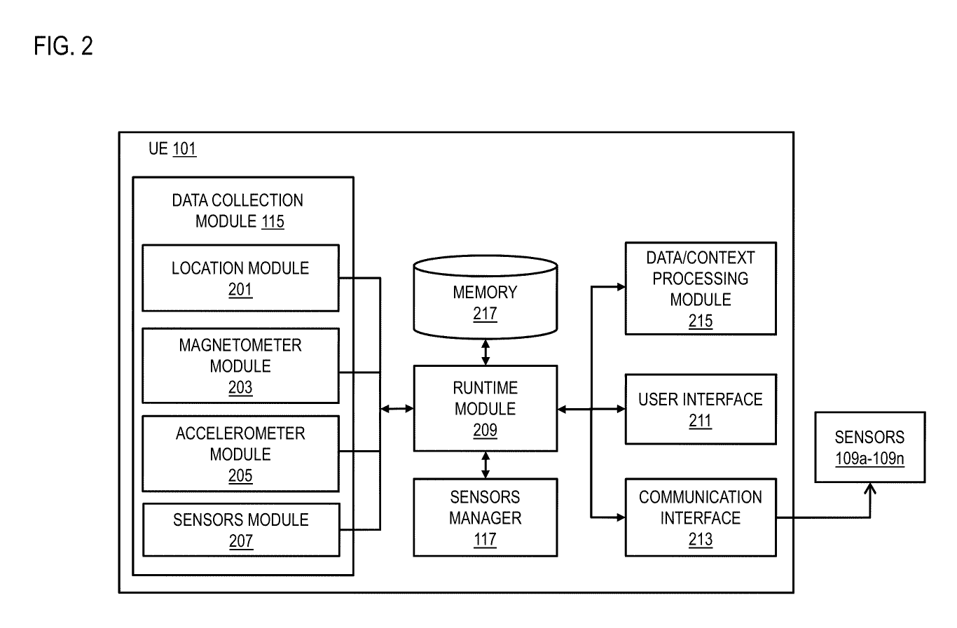

FIG. 2 is a diagram of the components of a user equipment capable of data collection and analysis for determining a user activity, according to an embodiment. By way of example, a UE 101 includes one or more components for receiving, collecting, generating, and/or analyzing sensor data to determine a user activity. It is contemplated that the functions of these components may be combined in one or more components or performed by other components of equivalent functionality. In this embodiment, the UE 101 includes a data collection module 115 that may include one or more location modules 201, magnetometer modules 203, accelerometer modules 205, and sensors modules 207. Further, the UE 101 may also include a runtime module 209 to coordinate the use of other components of the UE 101, a user interface 211, a communication interface 213, a data/context processing module 215, memory 217, and sensors manager 117. The applications 103 of the UE 101 can execute on the runtime module 209 utilizing the components of the UE 101.

The location module 201 can determine a user's location, for example, via location of a UE 101. The user's location can be determined by a triangulation system such as GPS, assisted GPS (A-GPS), Cell of Origin, or other location extrapolation technologies. Standard GPS and A-GPS systems can use satellites 111 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory 217 and are available to the sensors manager 117, the service provider 105, and/or to other entities of the system 100 via the communication interface 213. Moreover, in certain embodiments, the GPS coordinates can include an altitude to provide a height. In other embodiments, the altitude can be determined using another type of altimeter. In certain embodiments, the location module 201 can be a means for determining a location of the UE 101, an image, or used to associate an object in view with a location.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory 217, made available to other modules and/or applications 103 of the UE 101, and/or transmitted via the communication interface 213 to one or more entities of the system 100.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 205 can determine the angle the UE 101 is pointed as compared to Earth's gravity. In certain embodiments, the magnetometer module 203 and accelerometer module 205 can be means for ascertaining a perspective of a user. This perspective information may be stored in the memory 217, made available to other modules and/or applications 103 of the UE 101, and/or sent to one or more entities of the system 100.

In various embodiments, the sensors module 207 may include various sensors for detecting and/or capturing data associated with the user and/or the UE 101. For example, the sensors module 207 may include sensors for capturing environmental (e.g., atmospheric) conditions, audio, video, images, location information, temperature, user physiological data, user mood (e.g., hungry, angry, tired, etc.), user interactions with the UEs 101, and the like. In certain embodiments, information collected from and/or by the data collection module 115 can be retrieved by the runtime module 209, stored in memory 217, made available to other modules and/or applications 103 of the UE 101, and/or sent to one or more entities of the system 100.

The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc.

In one embodiment, the communication interface 213 can be used to communicate with one or more entities of the system 100. Certain communications can be via methods such as an internet protocol, messaging (e.g., SMS, MMS, etc.), or any other communication method (e.g., via the communication network 113). In some examples, the UE 101 can send context information associated with the UE 101 and/or the user to the service provider 105, C/A providers 107, and/or to other entities of the system 100.

The data/context processing module 215 may be utilized in determining context information from the data collection module 115 and/or applications 103 executing on the runtime module 209. For example, it can determine user activity, content consumption, application and/or service utilization, user information, type of information included in the data, information that may be inferred from the data, and the like. The data may be shared with the applications 103, and/or caused to be transmitted, via the communication interface 213, to the service provider 105 and/or to other entities of the system 100. The data/context processing module 215 may additionally be utilized as a means for determining information related to the user, various data, the UEs 101, and the like. Further, data/context processing module 215, for instance, may manage (e.g., organizes) the collected data based on general characteristics, rules, logic, algorithms, instructions, etc. associated with the data. In certain embodiments, the data/context processing module 215 can infer higher level context information from the context data such as favorite locations, significant places, common activities, interests in products and services, etc.

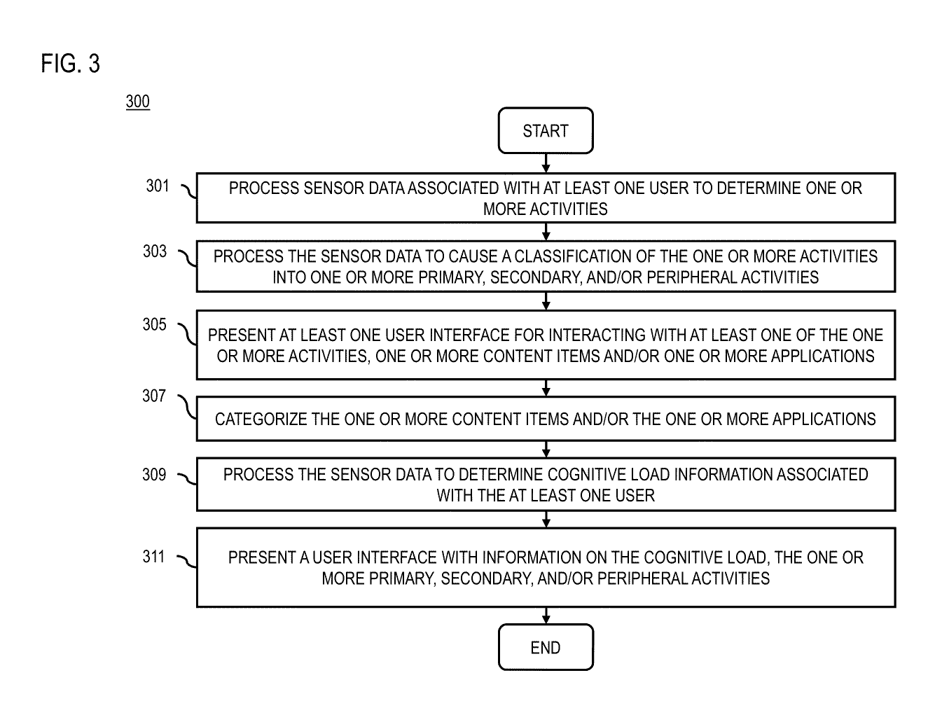

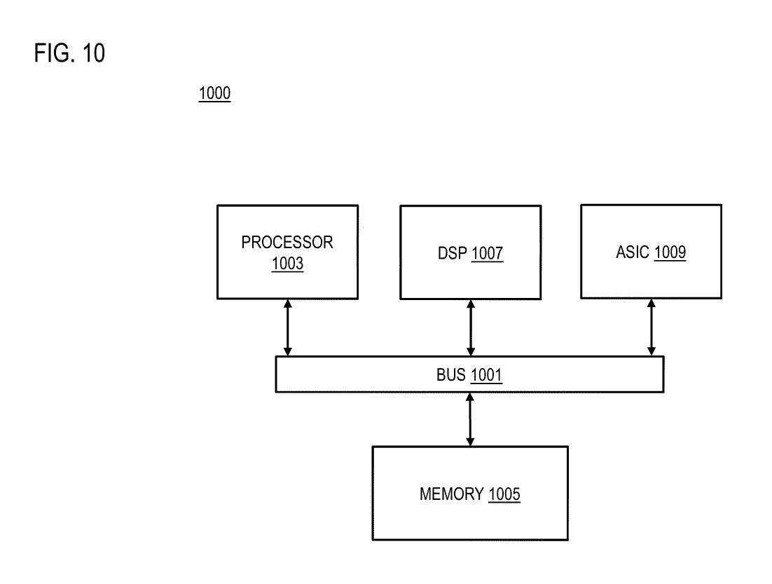

FIG. 3 is a flowchart of a process for, at least, processing sensor data to determine user classify user activities, according to an embodiment. In one embodiment, the data collection module 115 and/or the applications 103 perform the process 300 and are implemented in, for instance, a chip set including a processor and a memory as shown in FIG. 10. As such, the data collection module 115 and/or the applications 103 can provide means for accomplishing various parts of the process 300 as well as means for accomplishing other processes in conjunction with other components of the system 100. Throughout this process, the sensors and the data collection module 115 of the UE 101 are referred to as completing various portions of the process 300, however, it is understood that other components of the UE 101 and the system 100 can perform some of and/or all of the process steps. Further, in various embodiments, the sensors and the data collection module 115 may be referred to as implemented on a UE 101, however, it is understood that all or portions of the sensors and the data collection module 115 may be implemented in one or more entities of the system 100.

In step 301, the data collection module 115 processes and/or facilitates a processing of sensor data associated with at least one user to determine one or more activities. In various embodiments, a user may utilize one or more user devices (e.g., a personal computer, a mobile phone, a tablet, etc.), which may include various sensors (e.g., audio, video, image, GPS, accelerometer, etc.) for capturing and determining information about the user, the UEs 101, and/or environment of the user and/or the UEs 101. For example, the sensors may capture an image and/or audio sample of the user and utilize one or more activity recognition algorithms to determine if the user is sitting, speaking, walking, looking at a computer monitor, typing at the computer keyboard, looking at a certain direction, user gestures, facial expressions of the user, and the like. In one embodiment, the UE 101 may interact with other sensors in a spatial proximity, for example, available in a room (e.g., an office), in a building, outside (e.g., around a neighborhood), and the like.

In step 303, the data collection module 115 processes and/or facilitates a processing of the sensor data to cause, at least in part, a classification of the one or more activities into one or more primary activities, one or more secondary activities, one or more peripheral activities, or a combination thereof. In various embodiments, the applications 103, the sensors managers 117 and/or 121 may process sensor data captured by one or more sensors of the UE 101 and/or the sensors 109 in order to determine one or more classifications for the one or more activities, for example, as a primary activity, as one or more secondary activities, as one or more peripheral activities, and the like. In one instance, the sensor data may indicate that a user's primary activity is talking on a phone, but at the same time the user is utilizing as application to check for emails. In another example, the user's primary activity may be typing at a computer keyboard while listening and waiting for a conference call to begin. In one example, the user primary activity may be conducting a conference call on one UE 101, while viewing an instant message (IM) notification on another UE 101.

In step 305, the data collection module 115 causes, at least in part, a presentation of at least one user interface for interacting with at least one of the one or more activities, one or more content items, one or more applications, or a combination thereof based, at least in part, on the classification. In one embodiment, the applications 103 may present a UI including one or more diagrams, notifications, and/or elements for the user to review and interact with. For example, the user may select an element related to a primary activity, a phone call, to view additional information about the activity such as parties included in the activity, duration of the activity, applications in use, content items being consumed, and the like. In one example, the user may select from one or more secondary activities for further interaction such as reorder the classifications, rearrange the presentation, and the like. In one embodiment, the user may select to switch the classifications of the primary activity, that of the one or more secondary activities, and/or the one or more peripheral activities.

In step 307, the data collection module 115 causes, at least in part, a categorization of the one or more content items, the one or more applications, or a combination based, at least in part, on an association with the one or more primary activities, the one or more secondary activities, the one or more peripheral activities, or a combination thereof, wherein the at least one user interface depicts the one or more activities, the one or more content items, the one or more services, or a combination thereof based, at least in part, on the categorization. In one embodiment, a UI presentation may indicate one or more activities which utilize one or more content items and/or applications, wherein the content items and/or the applications may be categorized based on their association with the primary, secondary, and/or peripheral activities. For example, a UI diagram may present information that a user may be associated with a primary activity of an IM session, wherein a texting application is in use and wherein the texting application is categorized as being utilized by the user for a primary activity.

In step 309, the data collection module 115 processes and/or facilitates a processing of the sensor data to determine cognitive load information associated with the at least one user. In various embodiments, a user may be involved with one or more activities on one or more UEs 101, for example, a phone call, typing at a keyboard, reading a text message, taking part in a conversation, and the like, wherein one or more user sensory capabilities are being utilized. Further, the applications 103, the data collection module 115, and/or the sensors manager 117 may determine/infer/approximate the cognitive load of the user, for example, intellectual processing capability required for the user to execute and process information associated with the one or more activities, wherein the cognitive load information may be utilized (e.g., by a UE 101, a service provider, etc.) to determine how and/or when any interruptions by an application, by a service, by a content, and the like should be handled. In one embodiment, if a user is estimated to be experiencing a high cognitive load (e.g., due to a large number of concurrent tasks and/or loading nature of any given task), one or more presentations, recommendations, prompts, interruptions, and the like may be delayed and/or delivered with minimal impact on the user and/or current tasks in progress. For example, when a user is engaged in a visually demanding task (e.g., driving a vehicle, typing an email, etc.), a notification of an incoming phone call, an SMS, and the like should not require visual attention from the user so not to present additional load to visual modality of the user. In another embodiment, during a high cognitive load, notifications/interruptions may be stopped and/or filtered such that only high priority events and notifications are presented to the user.

In step 311, the data collection module 115 causes, at least in part, a presentation of the least one user interface depicting information associated with the cognitive load information, the one or more primary activities, the one or more secondary activities, the one or more peripheral activities, or a combination thereof in a primary, a secondary, or a peripheral section of the least one user interface. In various embodiments, the applications 103, the data collection module 115, and/or the service providers 105 may process one or more sensors data (e.g., audio, image, facial recognition, eye movement tracking, etc.) and determine that a user is more active with a secondary activity than with a primary activity, wherein a recommendation may be presented to the user (e.g., via UI) for switching user focus from one or more activities to one or more other activities currently presented, for example, switch focus from a primary to a secondary and/or a peripheral activity.

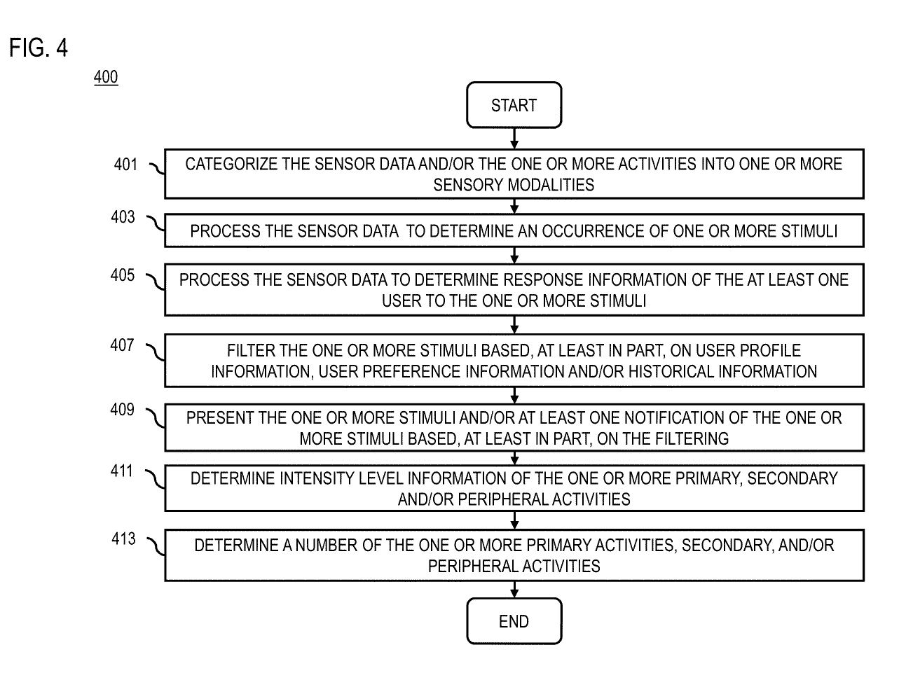

FIG. 4 is a flowchart of a process for, at least, categorizing the sensor data and determining one or more stimuli, according to an embodiment. In one embodiment, the data collection module 115 and/or the applications 103 perform the process 400 and are implemented in, for instance, a chip set including a processor and a memory as shown in FIG. 10. As such, the data collection module 115 and/or the applications 103 can provide means for accomplishing various parts of the process 400 as well as means for accomplishing other processes in conjunction with other components of the system 100. Throughout this process, the sensors and the data collection module 115 of the UE 101 are referred to as completing various portions of the process 400, however, it is understood that other components of the UE 101 and the system 100 can perform some of and/or all of the process steps. Further, in various embodiments, the sensors and the data collection module 115 may be referred to as implemented on a UE 101, however, it is understood that all or portions of the sensors and the data collection module 115 may be implemented in one or more entities of the system 100.

In step 401, data collection module 115 and/or the applications 103 causes, at least in part, a categorization of the sensor data, the one or more activities, or a combination thereof into one or more sensory modalities, wherein the presentation is with respect to the one or more sensory modalities. In various embodiments, the applications 103, the sensors manager 117 and/or 121, the service providers 105, and/or the data collection module 115 may process and categorize the one or more sensors data and/or the one or more user activities into one or more user sensory modalities. Further, the presentation and/or the recommendation to switch the primary and secondary activities may be based on the categorization associated with the one or more sensory modalities. For example, a primary activity is associated with an auditory modality (e.g., speaking on the phone) and a secondary activity is associated with typing at a keyboard; however, after some time, one or more sensors 109 and/or the sensors managers 117 and/or 121 determine that there is no auditory signals (e.g., user is not speaking, but still on the phone), wherein a recommendation is presented to the user for switching primary, secondary, and/or peripheral activities.

In step 403, data collection module 115 and/or the applications 103 processes and/or facilitates a processing of the sensor data to determine an occurrence of one or more stimuli. In various embodiments, the data collection module 115 and/or the sensors managers 117 and/or 121 may receive and/or process one or more sensor data available from one or more sensors on the UEs 101 and/or from the sensors 109, wherein the data may indicate occurrence of one or more stimuli from one or more sources. For example, a sensor may capture ringing of a phone, ringing of a door bell, a person walking into a room, a person speaking with a user, a notification of a reminder alarm on the UEs 101, and the like. In one embodiment, the one or more stimuli may be in close proximity with the user and/or may be at a distance from the user, but may still be detected by one or more sensors on the UEs 101 and/or the sensors 109. For example, a camera and a microphone may detect and/or record a presentation, which the user may wish to be notified of. In another example, a microphone may detect the name of a particular user being announced in a meeting room where the user is to be present at.

In step 405, data collection module 115 and/or the applications 103 In one embodiment, the system 100 processes and/or facilitates a processing of the sensor data to determine response information of the at least one user to the one or more stimuli; wherein the cognitive load information, the presentation, the classification of the one or more activities, or a combination thereof is based, at least in part, on the response information. In various embodiments, the one or more sensors on the UEs 101 and/or 109 may capture one or more responses by one or more users to the one or more stimuli, wherein the data collection module 115 may process and the one or more responses for determining one or more activities. Further, the applications 103, the data collection module 115, and/or the service provider 105 may determine one or more cognitive load information, presentations, classifications, and/or categorizations based on the one or more responses. For example, a user responds to a ringing telephone by answering it; a user responds to an IM on a UE 101; a user responds to another user by waving his hand, and the like.

In step 407, data collection module 115 and/or the applications 103 causes, at least in a part, a filtering of the one or more stimuli based, at least in part, on user profile information, user preference information, historical information, or a combination thereof. In one embodiment, the data collection module 115 and/or the applications 103 determine one or more stimuli intended for a user, wherein the one or more stimuli may be filtered (e.g., sorted) based on one or more parameters associated with the user and the UE 101. For example, one or more sensors may detect a stress level of the user (e.g., skin moisture galvanic skin response, heart rate variation, etc.) currently involved in one or more activities (e.g., speaking loudly into a UE 101, reviewing a slide show on another UE 101), when a notification of a new stimulus (e.g., an SMS message) is received by one or more UEs 101. In one embodiment, the filtering of the one or more stimuli may be based on a user profile, device profile, user history, location information, current activity level, current cognitive load, current user status, and the like.

In step 409, data collection module 115 and/or the applications 103 causes, at least in part, a presentation of the one or more stimuli, at least one notification of the one or more stimuli, or a combination thereof based, at least in part, on the filtering. In one embodiment, the system 100 can determine a scheduling for presenting the notification of the new stimulus so that there are no interruptions to the user at the current time (e.g., present the notification after the user is done with the call and the stress level is lower). In various embodiments, the applications 103 and/or the data collection module 115 may determine contextual information associated with one or more current activities of a user, wherein presentation of one or more notification of one or more subsequent stimuli may be determined based on the contextual information. For example, the user may be speaking on the phone with a client regarding a project for the client and concurrently typing a message at UE 101 keyboard intended for the client, when the user receives an urgent SMS from his colleague related to the project and/or the client, wherein the notification of the new urgent SMS is presented to the user without delay.

In step 411, data collection module 115 and/or the applications 103 determines intensity level information of the one or more primary activities, the one or more secondary activities, the one or more peripheral activities, or a combination thereof. In various embodiments, the one or more sensors on the UEs 101, the sensors 109, and/or the respective sensors managers 117 and/or 121 may process data captured by the one or more sensors for determining an intensity level associated with one or more activities of the user (e.g., physiological information of the user). For example, physical characteristics of a user and/or the UE 101 may be determined based on sensor data captured and processed indicative of one or more user physiological reactions, facial recognition, gesture detection, tone and/or level of voice, eye movements, UEs 101 movements, and the like.

In step 413, data collection module 115 and/or the applications 103 determines a number of the one or more primary activities, the one or more secondary activities, the one or more peripheral activities, or a combination thereof, wherein the cognitive load information is based, at least in part, on the intensity level information, the number, or a combination thereof. In various embodiments, the cognitive load information is calculated/determined based on the number of the user's primary and/or secondary activities and the respective intensity levels associated with the activities. For example, if a user is driving a car on a highway (e.g., at high speed, primary task) while speaking with a passenger in the car (e.g., secondary task), then the system 100 may determine that the user currently has a higher cognitive load (e.g., driving fast and conversing). In another example, a user may be walking around at a technical conference, reviewing a product brochure (e.g., primary activity) at a booth, listening to a representative describing information in the brochure (e.g., secondary activity), and listening to the overhead announcements for information on a particular presentation to begin in a few minutes (e.g., secondary activity), wherein the system 100 may determine a lower cognitive load for the user.

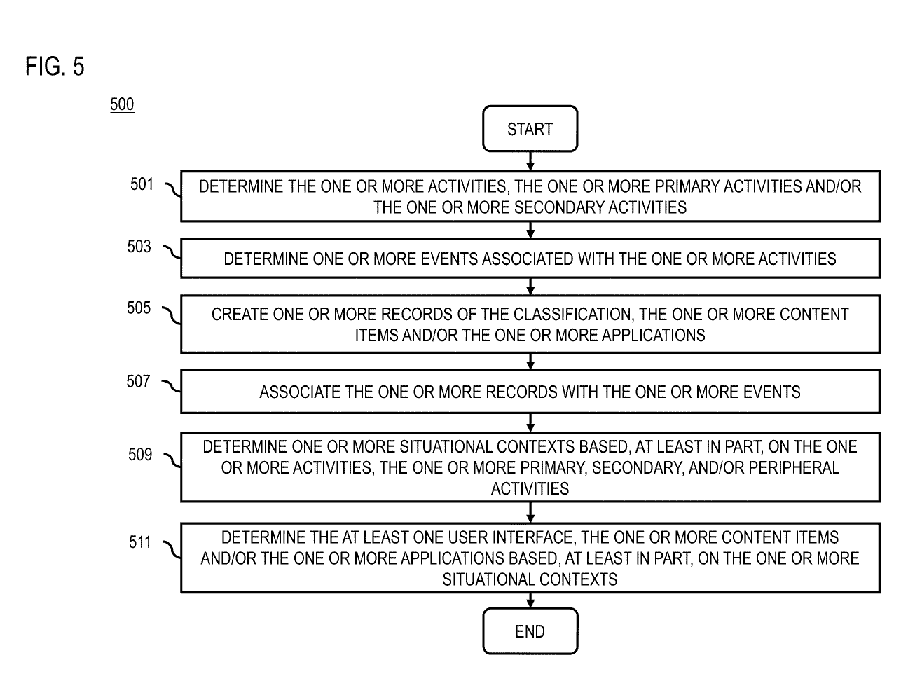

FIG. 5 is a flowchart of a process for, at least, determining one or more activities and associated events, according to an embodiment. In one embodiment, the data collection module 115 and/or the applications 103 perform the process 500 and are implemented in, for instance, a chip set including a processor and a memory as shown in FIG. 10. As such, the data collection module 115 and/or the applications 103 can provide means for accomplishing various parts of the process 500 as well as means for accomplishing other processes in conjunction with other components of the system 100. Throughout this process, the sensors and the data collection module 115 of the UE 101 are referred to as completing various portions of the process 500, however, it is understood that other components of the UE 101 and the system 100 can perform some of and/or all of the process steps. Further, in various embodiments, the sensors and the data collection module 115 may be referred to as implemented on a UE 101, however, it is understood that all or portions of the sensors and the data collection module 115 may be implemented in one or more entities of the system 100.

In step 501, data collection module 115 and/or the applications 103 determines the one or more activities, the one or more primary activities, the one or more secondary activities, the one or more peripheral activities, or a combination thereof based, at least in part, on a proximity to the at least one user, at least one device associated with the at least one user, or a combination thereof, wherein the proximity is based, at least in part, on a spatial proximity, a virtual proximity provided by one or more remote sensors, or a combination thereof. In one embodiment, the UE 101 may determine proximity (e.g., in a same room, at the next door office, at the meeting room on a different floor, in the backyard, etc.) of an activity in relation to the user and/or the UE 101, wherein the detection of the activity may be via the UE 101, one or more other UEs 101, one or more remote sensors, via the service provider 105, and the like. In one example, a UE 101 may detect a user of the UE 101 walking towards a meeting room while conversing on a phone via the UE 101 and/or a different UE 101, wherein the UE 101 may present a notification (e.g., the user is walking towards the meeting room) to another user via another UE 101 and/or sensors 109.

In step 503, data collection module 115 and/or the applications 103 determines one or more events associated with the one or more activities. In one embodiment, the applications 103 may determine contextual information associated with one or more user activities (e.g., speaking on a phone with a colleague) and one or more events which may be associated with the one or more activities. For example, the user may be discussing an office team meeting with a colleague, wherein the applications 103 and/or the data collection module 115 may determine that notifications (e.g., emails) may need to be sent out to members of the team. In one example, the UE 101 detects that a user is stopping his car at a fueling station (e.g., via a location sensor), determines that the fuel level is low (e.g., via a sensor in the car), infers that the user most likely will refuel the car, wherein the UE 101 calculates, presents, shares, and/or records a fuel consumption rate since last refueling of the car.

In step 505, data collection module 115 and/or the applications 103 causes, at least in part, a creation of one or more records of the classification, the one or more content items, the one or more applications, or a combination thereof. In various embodiments, the applications 103 and/or the data collection module 115 may create one or more records for the one or more classifications, content items, and/or applications associated with the one or more activities, the user, and/or the UEs 101. For example, a record may indicate an application utilized in one or more activities at a particular location, at a particular time, on a particular UE 101, and the like. In one example, an audio sample and an image capture may be associated with a record of one or more activities.

In step 507, data collection module 115 and/or the applications 103 causes, at least in part, an association of the one or more records with the one or more events. In various embodiments, the applications 103 and/or the service provider 105 may associate the one or more records with the one or more events, the one or more activities, and the like. For example, a transcript of a conference call is associated with the conference call having taken place earlier. In one example, a record of a meeting with a colleague may associate one or more parameters of the meeting (e.g., attendees, time, place, topics discussed, etc.) with the event of the meeting.

In step 509, data collection module 115 and/or the applications 103 determines one or more situational contexts based, at least in part, on the one or more activities, the one or more primary activities, the one or more secondary activities, the one or more peripheral activities, or a combination thereof. In one example, the user may be working in his backyard (e.g., a primary activity) while listening to music playing on a nearby music player (e.g., secondary activity), when a UE 101 near the user may detect (e.g., via a thermometer) that ambient temperature is rising and the user heart rate is increasing (e.g., via a sensor on the user body), wherein the UE 101 may produce a notification regarding the heat and his physiological condition. In one example, a user is at a party and engaged in a conversation with another person, wherein the UE 101 may detect (e.g., via audio sampling) name of the user being uttered by other persons nearby and presents a notification to the user via a UI

In step 511, data collection module 115 and/or the applications 103 determines the at least one user interface, the one or more content items, the one or more applications, or a combination thereof based, at least in part, on the one or more situational contexts. In one embodiment, the application 103 and/or the service provider 105 may determine an appropriate UI notification based on the situation of the user. For example, the user in the party of above example may be presented with a UI notification such that it is not intrusive (e.g., a short beep along with a short message on the UE 101 display) or noticeable by the other persons near the user. In one example, a user engaged in a conversation in a loud surrounding (e.g., at a bar in an airport) may receive a more robust notification (e.g., sounds, vibration, flashing screen, etc.) about a change in an imminent travel itinerary.

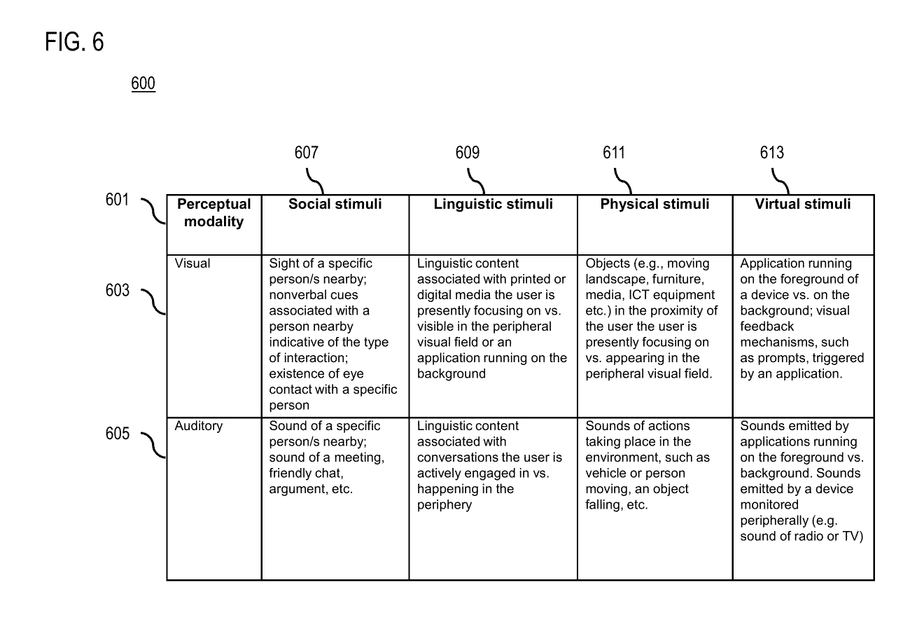

FIG. 6 shows table 600 including example sensors and possible various stimuli types, according to various embodiments. In various embodiments, perceptual modalities 601 includes visual modality 603 and auditory modality 605 elements that may be detected and may be situated in proximity of a user and/or on one or more UEs 101 used by the user. The table 600 includes various information/stimuli types, for example, social 607, linguistic 609, physical 611, and virtual 613 that can be collected and processed. In various embodiments, the data collections and/or the service provider 105 may determine and/or infer other information related to, for example, user activity (stationary, standing, walking, working, gardening, etc.), psycho-physiological state of the user, emotional state of the user, wherein the one or more information of the user may be compared to that of other users' nearby. Further, environmental conditions, such as ambient temperature, air quality, atmospheric conditions, and the like may be detected. Furthermore, the sensory modes may be expanded to cover other sensory information such as olfactory sensations as well as bodily sensations (e.g., proprioceptive, kinesthetic, etc.) In one embodiment, the sensors manager 117, the data collection module 115, and/or the applications 103 may process the sensor data collected along the one or more modalities for determining/inferring primary focus for each modality. For example, by inferring the user's one or more current activities and utilizing the inference information to further determine/infer/classify the one or more stimuli into a primary (e.g., feature in center of focus) and one or more secondary activities.

In one example, a user is situated in an office and the UE 101 (e.g., a mobile phone) is detecting sounds via its microphone. Further, the user is utilizing (e.g., wearing) a hands-free device (e.g., ear piece), which includes a microphone and a camera, wherein the hands-free device wirelessly transmits data including one or more audio/video recordings and/or image snapshots to the UE 101 for processing. In one embodiment, the user's visual field may be determined/inferred from the videos and/or the images captured by the hands-free device, which may indicate one or more stimuli in the user's visual focus and periphery areas including a computer monitor, textual content on the computer monitor, user's hands on top of a computer keyboard, a mobile device beside the keyboard, a wall, a window, a desk, and the like. In one example, the audio data may indicate and/or a microphone of the mobile device may detect/register sounds of typing on the keyboard along with an image/video of the user's hands on the keyboard, wherein the applications 103 and/or the data collection module 115 can determine that the user is currently typing at the keyboard. The fact that the user's primary activity is inferred to be typing is then used infer that the key stimulus in the center of the visual field of the user is the text appearing on the screen. Less central items include the wall, keyboard, mobile phone, and the window. In one embodiment, the user may be typing at the keyboard for a duration of time (e.g., 30 minutes), wherein cognitive load (e.g., concentration/intensity level) of the user may be inferred to be high since the user has been typing continuously for the past 30 minutes. Later, when the mobile device detects an incoming phone call, only a less intrusive notification (e.g., a short beep) is presented to the user with no visual indication displayed on the mobile device's display. In one embodiment, the type of incoming call notification is selected as the mobile device is deemed to be located at the periphery of the user's visual field, wherein a visual indication of the incoming call may distract the user from his primary task. In one embodiment, due to a relatively low ambient noise level in the room, an optimal incoming call notification signal may be determined to be a low volume short beep emitted by the mobile device.

In one embodiment, stress level of the user is approximated by inferring the intensity level of the primary task as well as the number of secondary and/or peripheral stimuli competing for the user attention. For instance, in the above described scenario of typing, the user's stress level may be estimated to be relatively low if there are no other distractions in the periphery visual field of the user. However, if one or more activities are detected nearby; for example, people are entering the room in the peripheral visual field, there are sounds in nearby background, etc., which are not related to the determined primary task (e.g., typing at the computer keyboard), then the stress level of the user may be inferred to be relatively high.

In one embodiment, one or more linguistic elements (e.g., detected to be in the user's visual or auditory fields) are analyzed for keywords, wherein the keywords may be utilized for conducting one or more searches for additional information on the UEs 101 and/or service provider 105, which may be applicable to the user's current situation.

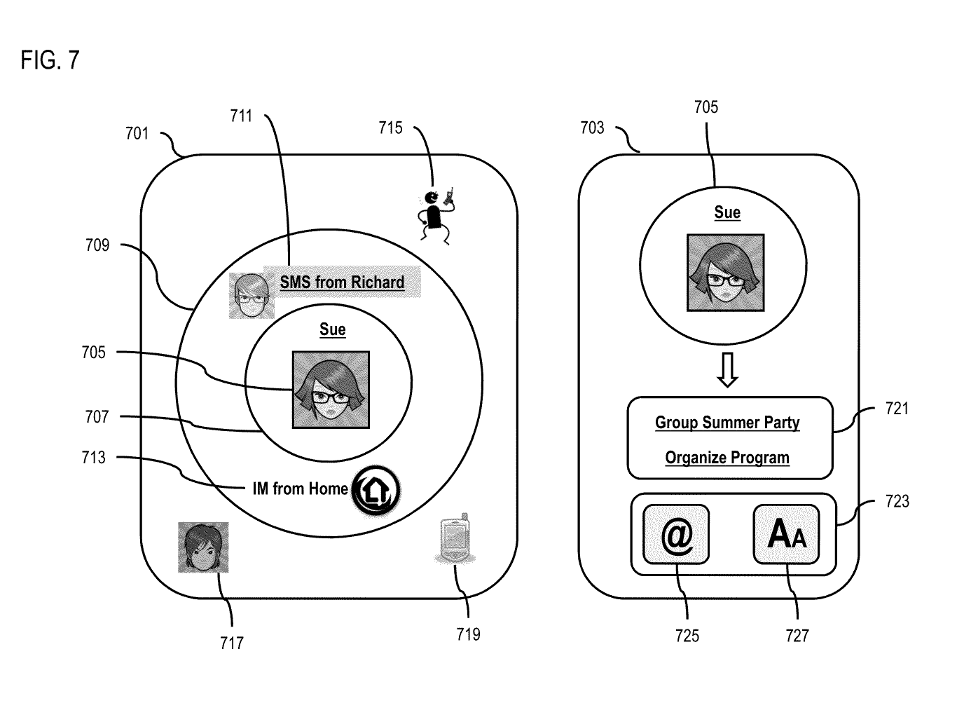

FIG. 7 illustrates examples of UI diagrams for interacting with the UE 101, according to various embodiments. The UI 701 depicts a situation where the UEs 101 and/or the service provider 105 may have interpreted a user of the UEs 101 to be having a primary activity of conversation with a person 705 (e.g., Sue). Further, the UI 701 may have various containment elements such as two circles 707 and 709 for presenting various primary and/or secondary activities of the user. Furthermore, since the conversation with Sue 705 is determined to be the primary task, this activity is placed at the center of the diagram in the circle 707. Moreover, concurrently, the UEs 101 may have detected one or more new activities for the user. For example, an SMS 711 has arrived (e.g., from Richard), which is classified as a secondary content item and is placed in the second circle 709; however, it is determined to contain information estimated to be important for the user and therefore, it is marked with additional informative effects (e.g., highlighted and underlined) in the UI.

Further, another activity instant message (IM) 713 is detected, which is also classified as a secondary content item and is placed in the second circle 709, but without any additional effects. In one embodiment, displaying of the notifications of the one or more activities (e.g., SMS, IM, etc.) may also be accompanied by a subtle vibration indicating to the user that one or more of the one or more new activities may contain important information/content, which may prompt/justify shifting the focus of the user (e.g., for a short while). In one embodiment, if the user chooses to shift his attention, then the new center of the focus (e.g. the SMS message) can be shifted into a central position on the UI presentation. In various embodiments, the system 100 may recognize multiple N number of events/activities associated with the user and/or the UEs 101 and then may determine/infer which stimulus should be represented in the center of the UI presentation vs. which should be at the periphery. As stated earlier, various sensors may “extend” sensory capabilities of the user by utilizing various sensor data to provide information to the user, which the user may not be aware of yet, that may update/assist with the user situational awareness.

In one embodiment, the UE 101 may determine and provide one or more peripheral events/information 715, 717, and 719 to a user, which may be in close proximity of the user and/or outside of the user sensory range, wherein indicators associated with the peripheral events may be presented in certain areas of the UI, may be marked, highlighted, and/or indicated that those events are currently peripheral to the user. In one instance, the UE 101 may determine that the user's supervisor 715 is approaching the user's office, for example, by detecting a close-proximity communication identification (e.g., Bluetooth® ID) associated with a UE 101 of the supervisor 715, via facial recognition by a camera outside the user office, and the like. In another instance, the sensor data may determine (e.g., via facial recognition, voice recognition, etc.) and indicate that a client 717 is in the parking lot and is approaching the user's office building.

In another instance, the UE 101 may register/determine (e.g., via Bluetooth®) that another user device 719 associated with the user is receiving a phone call, but it is in silent-mode and cannot provide a noticeable (e.g., ring, vibrate, flash, etc.) alert for the user at this time. In various embodiments, the user may choose to move any of the primary, secondary, and/or peripheral events into a different category and/or the system 100 may recommend and/or determine a change in the category of the one or more events and render a UI presentation based on the one or more updated categories. For example, a recommendation may be to switch the secondary tasks 711 and 713 to the periphery, and move the peripheral tasks 715 and 717 to secondary and/or primary tasks. I one embodiment, the user may or may not be aware of one or more peripheral activities.

Additionally, the UI element 703 continues to depict the primary task of the user having a conversation with Sue 705, which is now depicted in a single circle for presenting a visualization focused on amplifying/supplementing the primary task. In one embodiment, the data collection module 115 and/or the applications 103 may determine one or more contextual information items from processing and/or analyzing the conversation for highlighting one or more themes extracted from the conversation. In one example, the conversation is about an upcoming summer party and organizing a program for the party, wherein the two themes 721 are displayed in the user interface 703 which may be utilized to cause one or more actions 723 by the UEs 101. In one embodiment, the user may choose/drag either of the themes in 721 to email icon 725, which may cause the applications 103 and/or the service provider 105 to generate and transmit one or more email messages to individuals and/or groups determined/inferred by the applications 103 and/or the service provider 105 to be relevant recipients. In one embodiment, various information items may also be included in the body of the one or more email messages pertaining to the ongoing conversation. Similarly, the user may choose/drag either of the themes in 721 to text icon 727 to the text icon, which can substantially automatically generate one or more recordations of notes pertaining to the conversation.

In various embodiments, the system 100 can keep track of the items and processes the user is focusing on in the course of the day. Processes deemed to be important (based on e.g. a strong physiological response) may be substantially automatically recorded and summarized. For example, recordation of important events and processes may as a diary, wherein the diary events may resonate well with the subjective experience of the user.

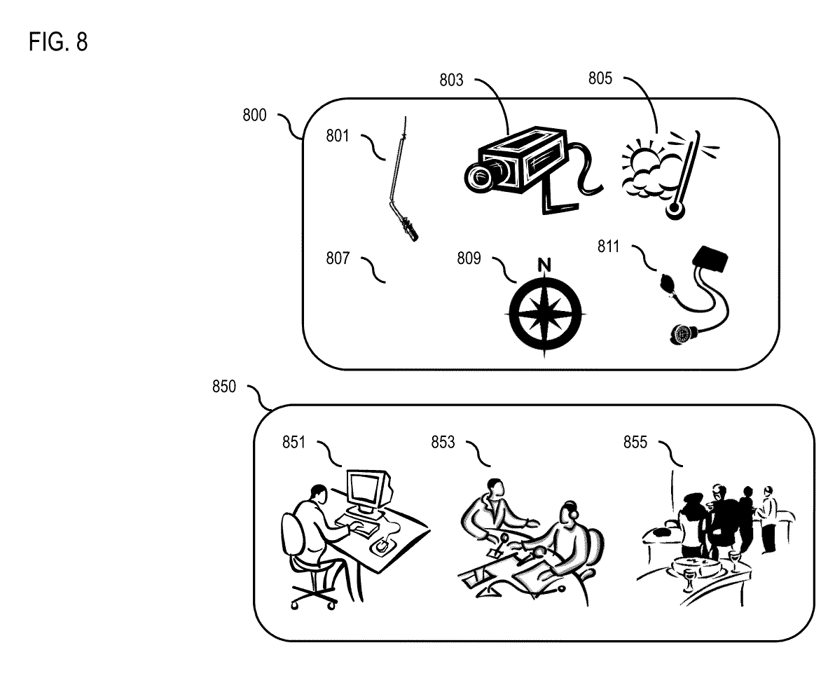

FIG. 8 illustrates various devices for detecting sensory data in various user situations, according to various embodiments. In various embodiments, various sensors 800 for detecting audio 801, imagery 803, atmospheric conditions 805, various container levels 807, location/direction 809, health/wellness 811, a near-eye display, other accessories, and the like may be available on the UEs 101, on one or more users (e.g., wearable), in a spatial proximity of one or more users and/or UEs 101 (e.g., in a room), in a vehicle, outside of a building, at a remote location, and the like. In various embodiments, 850 shows various user situations including 851 where a user is interfacing with various UEs 101 (e.g., an office); 853 where multiple users may be interacting with each other and/or with one or more UEs 101 (e.g., a meeting room); 855 where multiple users may be interacting with each other (e.g., a party), wherein various UEs 101 may be available. In various embodiments, one or more UEs 101 of one or more users may interact with one or more other UEs 101 for determining, sharing, processing, and the like of one or more sensory data.

The processes described herein for processing sensory data, presenting situational awareness information, and providing adaptive services and content to the user providing may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

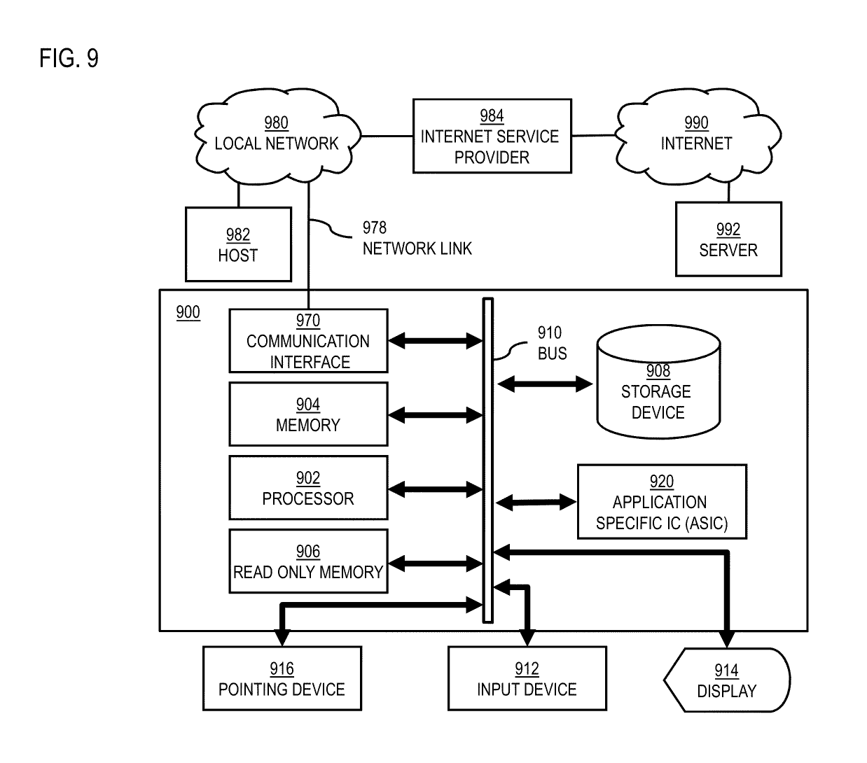

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to process sensory data, determine situational awareness of a user, and provide adaptive services and content to the user as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of processing sensory data, presenting situational awareness information, and providing adaptive services and content to the user.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to processing sensory data, presenting situational awareness information, and providing adaptive services and content to the user. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for processing sensory data, presenting situational awareness information, and providing adaptive services and content to the user. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for processing sensory data, presenting situational awareness information, and providing adaptive services and content to the user, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 113 for processing sensory data, presenting situational awareness information, and providing adaptive services and content to the user.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to process sensory data, determine situational awareness of a user, and provide adaptive services and content to the user as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of processing sensory data, presenting situational awareness information, and providing adaptive services and content to the user.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to process sensory data, determine situational awareness of a user, and provide adaptive services and content to the user. The memory 1005 also stores the data associated with or generated by the execution of the inventive steps.

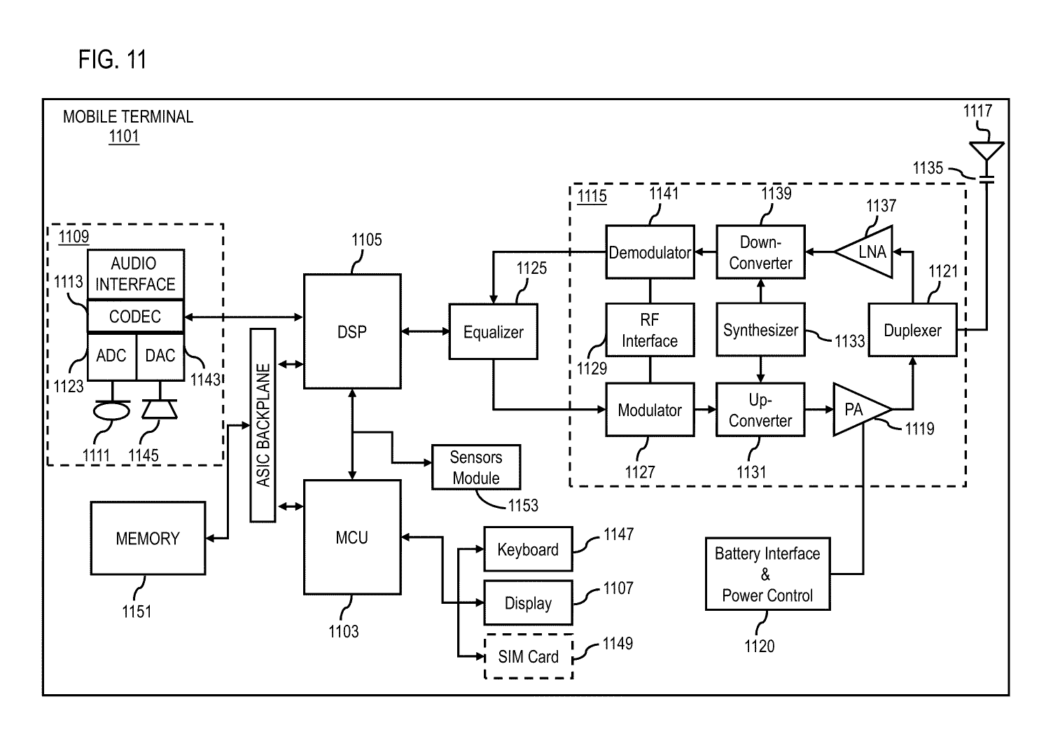

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of processing sensory data, presenting situational awareness information, and providing adaptive services and content to the user. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of processing sensory data, presenting situational awareness information, and providing adaptive services and content to the user. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to process sensory data, determine situational awareness of a user, and provide adaptive services and content to the user. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Additionally, sensors module 1153 may include various sensors, for instance, a location sensor, a speed sensor, an audio sensor, an image sensor, a brightness sensor, a biometrics sensor, various physiological sensors, a directional sensor, and the like, for capturing various data associated with the mobile terminal 1101 (e.g., a mobile phone), a user of the mobile terminal 1101, an environment of the mobile terminal 1101 and/or the user, or a combination thereof, wherein the data may be collected, processed, stored, and/or shared with one or more components and/or modules of the mobile terminal 1101 and/or with one or more entities external to the mobile terminal 1101.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of sensor data associated with at least one user to determine one or more activities;
a processing of the sensor data to cause, at least in part, a classification of the one or more activities into one or more primary activities, one or more secondary activities, one or more peripheral activities, or a combination thereof; and
a presentation of at least one user interface for interacting with at least one of the one or more activities, one or more content items, one or more applications, or a combination thereof based, at least in part, on the classification.

2. A method of claim 1, wherein the (1) data and/or (2) information and/or (3) at least one signal are further based, at least in part, on the following:
a categorization of the one or more content items, the one or more applications, or a combination based, at least in part, on an association with the one or more primary activities, the one or more secondary activities, the one or more peripheral activities, or a combination thereof,
wherein the at least one user interface depicts the one or more activities, the one or more content items, the one or more services, or a combination thereof based, at least in part, on the categorization.

3. A method of claim 1, wherein the (1) data and/or (2) information and/or (3) at least one signal are further based, at least in part, on the following:
a processing of the sensor data to determine cognitive load information associated with the at least one user; and
a presentation of the least one user interface depicting information associated with the cognitive load information, the one or more primary activities, the one or more secondary activities, the one or more peripheral activities, or a combination thereof in a primary, a secondary, or a peripheral section of the least one user interface.

4. A method of claim 3, wherein the (1) data and/or (2) information and/or (3) at least one signal are further based, at least in part, on the following:
a categorization of the sensor data, the one or more activities, or a combination thereof into one or more sensory modalities,
wherein the presentation is with respect to the one or more sensory modalities.

5. A method of claim 3, wherein the (1) data and/or (2) information and/or (3) at least one signal are further based, at least in part, on the following:
a processing of the sensor data to determine an occurrence of one or more stimuli; and
a processing of the sensor data to determine response information of the at least one user to the one or more stimuli,
wherein the cognitive load information, the presentation, the classification of the one or more activities, or a combination thereof is based, at least in part, on the response information.

6. A method of claim 3, wherein the (1) data and/or (2) information and/or (3) at least one signal are further based, at least in part, on the following:
a filtering of the one or more stimuli based, at least in part, on user profile information, user preference information, historical information, or a combination thereof; and
a presentation of the one or more stimuli, at least one notification of the one or more stimuli, or a combination thereof based, at least in part, on the filtering.

7. A method of claim 3, wherein the (1) data and/or (2) information and/or (3) at least one signal are further based, at least in part, on the following:
at least one determination of intensity level information of the one or more primary activities, the one or more secondary activities, the one or more peripheral activities, or a combination thereof; and
at least one determination of a number of the one or more primary activities, the one or more secondary activities, the one or more peripheral activities, or a combination thereof,
wherein the cognitive load information is based, at least in part, on the intensity level information, the number, or a combination thereof.

8. A method of claim 1, wherein the (1) data and/or (2) information and/or (3) at least one signal are further based, at least in part, on the following:
at least one determination of the one or more activities, the one or more primary activities, the one or more secondary activities, the one or more peripheral activities, or a combination thereof based, at least in part, on a proximity to the at least one user, at least one device associated with the at least one user, or a combination thereof,
wherein the proximity is based, at least in part, on a spatial proximity, a virtual proximity provided by one or more remote sensors, or a combination thereof.

9. A method of claim 1, wherein the (1) data and/or (2) information and/or (3) at least one signal are further based, at least in part, on the following:
at least one determination of one or more events associated with the one or more activities;
a creation of one or more records of the classification, the one or more content items, the one or more applications, or a combination thereof; and
an association of the one or more records with the one or more events.

10. A method of claim 1, wherein the (1) data and/or (2) information and/or (3) at least one signal are further based, at least in part, on the following:
at least one determination of one or more situational contexts based, at least in part, on the one or more activities, the one or more primary activities, the one or more secondary activities, the one or more peripheral activities, or a combination thereof; and
determining the at least one user interface, the one or more content items, the one or more applications, or a combination thereof based, at least in part, on the one or more situational contexts.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of sensor data associated with at least one user to determine one or more activities;
process and/or facilitate a processing of the sensor data to cause, at least in part, a classification of the one or more activities into one or more primary activities, one or more secondary activities, one or more peripheral activities, or a combination thereof; and
cause, at least in part, a presentation of at least one user interface for interacting with at least one of the one or more activities, one or more content items, one or more applications, or a combination thereof based, at least in part, on the classification.

12. An apparatus of claim 11, wherein the apparatus is further caused to:
cause, at least in part, a categorization of the one or more content items, the one or more applications, or a combination based, at least in part, on an association with the one or more primary activities, the one or more secondary activities, the one or more peripheral activities, or a combination thereof,
wherein the at least one user interface depicts the one or more activities, the one or more content items, the one or more services, or a combination thereof based, at least in part, on the categorization.

13. An apparatus of claim 11, wherein the apparatus is further caused to:
process and/or facilitate a processing of the sensor data to determine cognitive load information associated with the at least one user; and
cause, at least in part, a presentation of the least one user interface depicting information associated with the cognitive load information, the one or more primary activities, the one or more secondary activities, the one or more peripheral activities, or a combination thereof in a primary, a secondary, or a peripheral section of the least one user interface.

14. An apparatus of claim 13, wherein the apparatus is further caused to:
cause, at least in part, a categorization of the sensor data, the one or more activities, or a combination thereof into one or more sensory modalities,
wherein the presentation is with respect to the one or more sensory modalities.

15. An apparatus of claim 13, wherein the apparatus is further caused to:
process and/or facilitate a processing of the sensor data to determine an occurrence of one or more stimuli; and
process and/or facilitate a processing of the sensor data to determine response information of the at least one user to the one or more stimuli;
wherein the cognitive load information, the presentation, the classification of the one or more activities, or a combination thereof is based, at least in part, on the response information.

16. An apparatus of claim 13, wherein the apparatus is further caused to:
cause, at least in a part, a filtering of the one or more stimuli based, at least in part, on user profile information, user preference information, historical information, or a combination thereof; and
cause, at least in part, a presentation of the one or more stimuli, at least one notification of the one or more stimuli, or a combination thereof based, at least in part, on the filtering.

17. An apparatus of claim 13, wherein the apparatus is further caused to:
determine intensity level information of the one or more primary activities, the one or more secondary activities, the one or more peripheral activities, or a combination thereof; and
determine a number of the one or more primary activities, the one or more secondary activities, the one or more peripheral activities, or a combination thereof,
wherein the cognitive load information is based, at least in part, on the intensity level information, the number, or a combination thereof.

18. An apparatus of claim 11, wherein the apparatus is further caused to:
determine the one or more activities, the one or more primary activities, the one or more secondary activities, the one or more peripheral activities, or a combination thereof based, at least in part, on a proximity to the at least one user, at least one device associated with the at least one user, or a combination thereof,
wherein the proximity is based, at least in part, on a spatial proximity, a virtual proximity provided by one or more remote sensors, or a combination thereof.

19. An apparatus of claim 11, wherein the apparatus is further caused to:
determine one or more events associated with the one or more activities;
cause, at least in part, a creation of one or more records of the classification, the one or more content items, the one or more applications, or a combination thereof; and
cause, at least in part, an association of the one or more records with the one or more events.

20. An apparatus of claim 11, wherein the apparatus is further caused to:
determine one or more situational contexts based, at least in part, on the one or more activities, the one or more primary activities, the one or more secondary activities, the one or more peripheral activities, or a combination thereof; and
determine the at least one user interface, the one or more content items, the one or more applications, or a combination thereof based, at least in part, on the one or more situational contexts.

21-48. (canceled)
